(19) United States
(12) Patent Application Publication
(10) Pub. No.: US 2025/0303586 A1
(43) Pub. Date: Oct. 2, 2025

(54) HOLDING DEVICE

(71) Applicant: Samsung Electronics Co., Ltd., Suwon-si (KR)

(72) Inventors: Koichiro MATSUMOTO, Yokohama-shi (JP); Mineki TAOKA, Yokohama-shi (JP); Takeshi YAMAGISHI, Yokohama-shi (JP); Yuki ABE, Yokohama-shi (JP)

(21) Appl. No.: 19/092,516

(22) Filed: Mar. 27, 2025

Related U.S. Application Data
(63) Continuation of application No. PCT/KR2025/003943, filed on Mar. 27, 2025.

(30) Foreign Application Priority Data
Mar. 27, 2024 (JP) 2024-050936

(51) Int. Cl. B25J 15/06; G06T 7/73; G06V 10/14; G06V 20/50

(52) U.S. Cl. CPC B25J 15/0683; G06T 7/73; G06V 10/14; G06V 20/50; G06T 2207/30204

(57) ABSTRACT

A holding device is provided. The holding device includes a housing including an opening, a contact part covering the opening of the housing, formed of an elastic body having a transmittance, and configured to contact an object to hold the object, a camera part disposed in the housing and configured to capture an image for a surface of the contact part and the object, and an identification device configured to identify a contact state of the object and the contact part based on the image.

### CROSS-REFERENCE TO RELATED APPLICATION(S)

This application is a continuation application, claiming priority under 35 U.S.C. § 365 (c), of an International application No. PCT/KR2025/003943 filed on Mar. 27, 2025, which is based on and claims priority under 35 U.S.C. § 119 (a) of a Japanese patent application number 2024-050936, filed on Mar. 27, 2024, in the Japanese Patent Office, the disclosure of which is incorporated by reference herein in its entirety.

### TECHNICAL FIELD

The disclosure relates to a holding device.

### DESCRIPTION OF RELATED ART

For example, a robot arm uses a holding device for detecting and holding an object using a tactile sensor. Patent document 1 discloses a tactile sensor including a transmitting portion having a first surface contactable to a holding target and a second surface opposite to the first surface, a photographing part capable of capturing an image of an object present on the first surface side of the transmitting portion from the second surface side, and a reflecting unit disposed on the second surface side of the transmitting unit to reflect the light from at least a partial area of the transmitting unit and guiding the light within the photographing viewing angle of the photographing part.

### PRIOR ART LITERATURE

### Patent Document

International Patent Application Publication No. 2021/001992

The above information is presented as background information only to assist with an understanding of the disclosure. No determination has been made, and no assertion is made, as to whether any of the above might be applicable as prior art with regard to the disclosure.

### SUMMARY

When holding an object by, e.g., a robot arm, it is required to stably hold the object while grasping the posture by recognizing various objects.

Aspects of the disclosure are to address at least the above-mentioned problems and/or disadvantages and to provide at least the advantages described below. Accordingly, an aspect of the disclosure is to provide a holding device capable of stably holding an object by grasping the posture of the object.

Additional aspects will be set forth in part in the description which follows and, in part, will be apparent from the description, or may be learned by practice of the presented embodiments.

In accordance with an aspect of the disclosure, a holding device is provided. The holding device includes a housing including an opening, a contact part covering the opening of the housing, formed of an elastic body having a transmittance, and configured to contact an object to hold the object, a camera part disposed in the housing and configured to capture an image for a surface of the contact part and the object, and an identification device configured to identify a contact state of the object and the contact part based on the image

The contact part includes a suction hole for sucking air and wherein the holding device is configured to suck the object by sucking air from the suction hole by aligning a position of the suction hole to a position of the object.

A marker by a predetermined geometric pattern is attached to a surface, contacting the object, of the contact part. The identification device is configured to identify the contact state of the object held on the contact part based on an amount of displacement of the marker in the image captured by the camera part.

A film formed of a resin having a transmittance is provided on a surface, configured to contact the object, of the contact part.

A marker by a predetermined pattern is attached to the film formed on the contact part. The identification device is configured to identify the contact state of the object held on the contact part based on an deformation of the marker in the image captured by the camera part.

The holding device further includes a lighting part configured to radiate light for photographing by the camera part to the contact part from an inside of the housing.

The camera part includes a light receiving element group configured to output an electrical signal according to light reception and a plurality of optical systems configured to form a plurality of images on the light receiving element group.

The plurality of optical systems of the camera part includes a lens and an aperture plate having a plurality of openings to allow a plurality of incident light beams to be incident on the lens to allow light passing through the lens to form the plurality of images on the light receiving element group.

The plurality of optical systems of the camera part includes a first optical system configured to form an image on the light receiving element group by adjusting a focal length to a surface, configured to contact the object, of the contact part and a second optical system configured to form the image on the light receiving element group by adjusting the focal length to a position farther than the surface, contacting the object, of the contact part.

The lens comprises one lens having a long distance focus set at a first part of the lens and a short distance focus set at a second part of the lens.

The light receiving element group comprises an image sensor, an image from the first part of the lens is formed on a first part of the image sensor and an image from the second part of the lens is formed on a second part of the image sensor.

The lens comprises a meta lens.

According to the disclosure, it is possible to stably hold an object by grasping the posture of the object.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an outer appearance of a holding device having an optical tactile sensor (OTS) feature according to an embodiment of the disclosure;

FIG. 2 is a cross-sectional view illustrating an internal structure of the holding device of FIG. 1 according to an embodiment of the disclosure;

FIG. 3 is a view illustrating a suction structure of a holding device according to an embodiment of the disclosure;

FIG. 4 is a view illustrating a structure of a bottom plate according to an embodiment of the disclosure;

FIG. 5 is a view illustrating a configuration of an optical system of a holding device camera part according to an embodiment of the disclosure;

FIG. 6 is a view illustrating an example of a configuration of a camera part according to an embodiment of the disclosure;

FIG. 7 is a view schematically illustrating a configuration of obtaining two images in short and long distances by a camera part according to an embodiment of the disclosure;

FIG. 8 is a view schematically illustrating another configuration of obtaining two images in short and long distances by a camera part according to an embodiment of the disclosure;

FIG. 9 is a view illustrating a state in which a holding device detects a connector, as an object, and a socket where the connector is to be mounted according to an embodiment of the disclosure;

FIG. 10 is a view illustrating a state in which a holding device holds a connector according to an embodiment of the disclosure;

FIG. 11 is a view illustrating a state in which a connector held by a holding device is mounted in a socket according to an embodiment of the disclosure;

FIG. 12 is a view illustrating a state in which a holding device releases holding of a connector according to an embodiment of the disclosure;

FIG. 13 is a view illustrating an example of a hardware configuration of a processing device according to an embodiment of the disclosure;

FIG. 14 is a view illustrating a functional configuration of a processing device according to an embodiment of the disclosure;

FIG. 15 illustrates an example of displacement of a marker; part (A) of FIG. 15 is a view illustrating an initial state of the marker, part (B) of FIG. 15 is a view illustrating a state of the marker at time t, and part (C) of FIG. 15 is a view illustrating a state in which the positions of the marker of parts (A) and (B) of FIG. 15 overlap according to an embodiment of the disclosure;

FIG. 16 is a view illustrating an example in which dots overlap when one dot is displaced according to an embodiment of the disclosure;

FIG. 17 is a view illustrating correspondence between a plurality of dots according to an embodiment of the disclosure;

FIG. 18 is a view illustrating a dot excluded from a tracking target in the example of part (C) of FIG. 15 according to an embodiment of the disclosure;

FIG. 19 is a view illustrating an example of first displacement according to an embodiment of the disclosure;

FIG. 20 is a view illustrating an example of second displacement according to an embodiment of the disclosure;

FIG. 21 is a graph illustrating a relationship between force applied to a contact part of a holding device and the amount of deformation of the contact part according to an embodiment of the disclosure; and

FIGS. 22A, 22B, and 22C illustrate examples of operation of a holding device; FIG. 22(A) is a view illustrating a state in which the holding device holds an object, FIG. 22(B) is a view illustrating a state in which the holding device installs the object at an installation position, and FIG. 22(C) is a view illustrating a state in which the object is properly installed at the installation position according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

### <System Configuration>

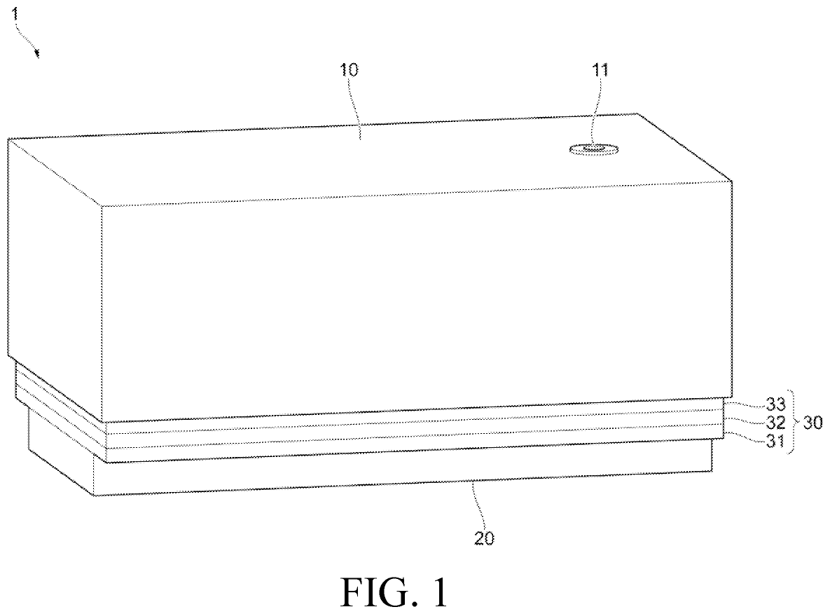

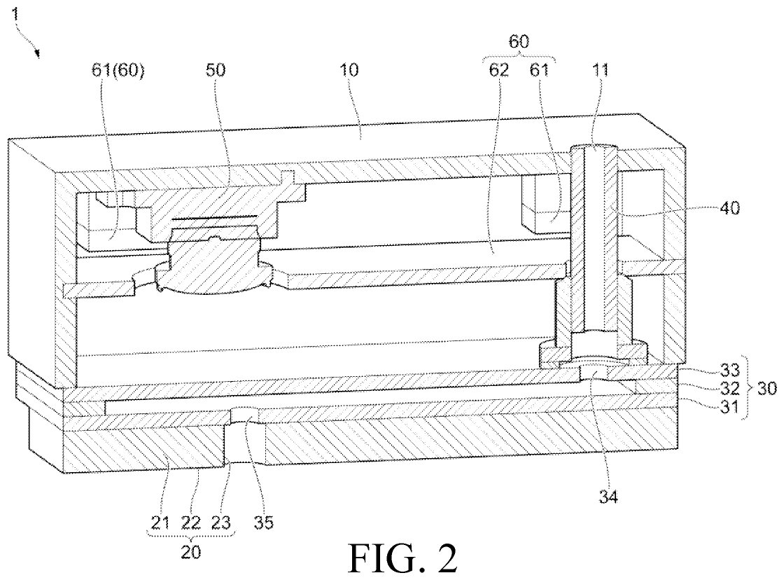

FIG. 1 is a view illustrating an outer appearance of a holding device having an optical tactile sensor (OTS) feature according to an embodiment of the disclosure. FIG. 2 is a cross-sectional view illustrating an internal structure of the holding device of FIG. 1 according to an embodiment of the disclosure.

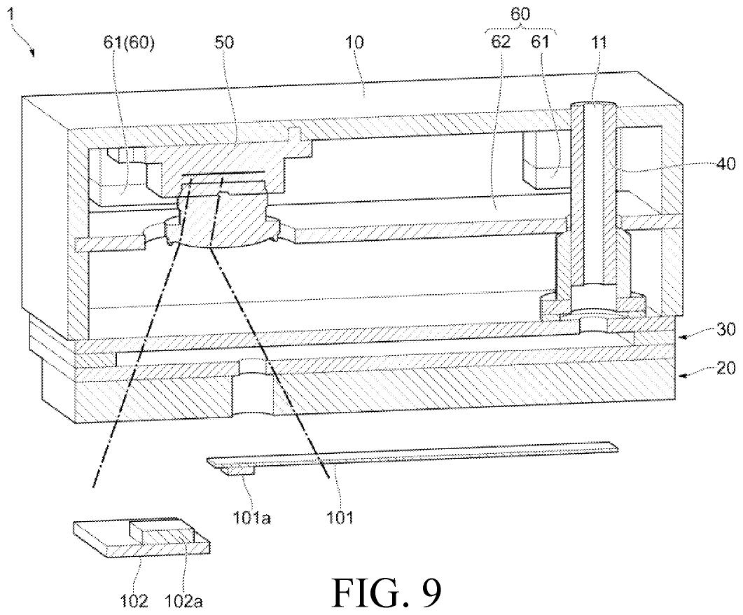

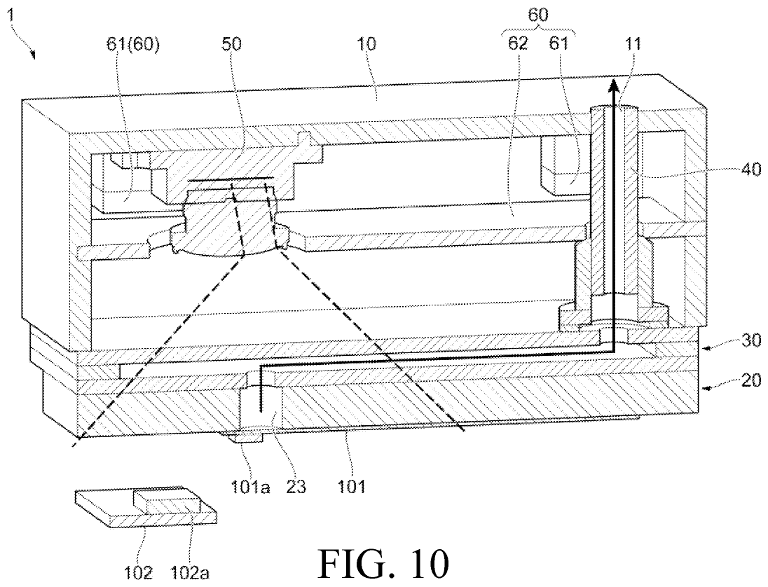

A holding device 1 according to an embodiment includes a housing 10, a contact part 20, and a bottom plate 30. The holding device 1 holds a holding contact between a target (e.g., connector 101a in FIGS. 9 and 10) (hereinafter, simply referred to as an object) and the bottom plate 30 side. A suction container 40, a camera part 50, and a lighting part 60 are accommodated in the housing 10.

The holding device may refer to a device configured to suck or grip an external object for movement. However it is not limited thereto.

Although not shown, the holding device 1 is installed at the front end of the arm part (robot arm) and is movable. Further, a suction device (not shown) that sucks air on the surface side in contact with the object of the holding device 1 is connected to the holding device 1. The holding device 1 sucks and holds the object by suctioning air by the suction device. A detailed description of the method of holding the object by the holding device 1 is given below. The holding device 1, the arm part (robot arm), and the suction device are controlled by a control device (not shown). The control device is implemented, e.g., by a computer. The holding device 1 is moved by the operation of the arm part based on the control of the control device, holds the object and installs it at the installation position.

Further, the holding device 1 has a processing device (not shown) installed outside the housing 10. According to one embodiment, the holding device (1) may constitute a holding system, including the processing device (e.g., connector 101a in FIGS. 9 and 10). The processing device (e.g., connector 101a in FIGS. 9 and 10) may detect the object or identify the state of the object held by the contact part 20 based on the image data captured by the camera part 50. Here, as an example of identify the state of the object, it may include identifying the contact state between the contact part 20 and the object (e.g., connector 101a in FIGS. 9 and 10) The processing device is implemented, e.g., by a computer. As an embodiment, the processing device and the control device may be implemented by the same computer.

In other words, the holding device in this disclosure configured to identify the contact state between the contact part 20 and the object (e.g., connector 101a in FIGS. 9 and 10). The processing device in this disclosure has the same name as the identification device. The identification device in this disclosure may include means for identifying the contact state between the object (e.g., connector 101a in FIGS. 9 and 10) and the contact part 20. As an example, the means for identifying the contact state between the maintenance target object and the contact portion (20) may include attaching a marker to the contact portion (20) and identifying the deformation of the marker when the contact portion (20) comes into contact with the object (e.g., the connector (101a) in FIGS. 9 and 10). This will be described in detail below.

In this disclosure identification (or identify) include estimation (or estimate). In this disclosure object refer to an external object or the connector in FIG. 9 or 10. However this is merely an example, and the object refer to any object that contact to the contact part 20 of the holding device 1.

The housing 10 shown in FIG. 1 is rectangular, and has one open surface (lower surface in the drawing). The open surface of the housing 10 is a surface in contact with the object. The housing 10 is formed of, e.g., resin or metal. A discharge hole 11 is formed in a part (an upper surface in the drawing) of the housing 10. A suction device (not shown) is connected to the discharge hole 11.

The bottom plate 30 is a plate-shaped member covering the open surface of the housing 10. The bottom plate 30 has a three-layer structure of a first layer 31, a second layer 32, and a third layer 33. The first layer 31 to the third layer 33 are formed of a member (e.g., a resin such as acrylic) having a certain degree of hardness and light transmittance. A through hole 35 is formed in the first layer 31 of the bottom plate 30. A through hole 34 is formed in the third layer 33. A space (air flow path) connecting the through hole 35 and the through hole 34 is formed in the second layer 32. A detailed description of the configuration of the bottom plate 30 is given below.

The contact part 20 includes a transparent elastic body 21 and a film 22 covering the surface of the transparent elastic body 21. The transparent elastic body 21 is formed of a member having light transmittance to visible light and elasticity. The transparent elastic body 21 is formed using, e.g., gel such as an elastomer. Examples of the elastomer include optically transparent elastomers such as silicone rubber, polyurethane, plastisol, natural rubber, polyisoprene, polyvinyl chloride, and other thermoplastic elastomers.

The film 22 is formed of a resin having light transmittance to visible light and deformable. The film 22 is formed by attaching a film to the surface of the transparent elastic body 21, or applying a member, which is attached and then filmed, to the surface of the transparent elastic body 21. By forming the film 22, the surface of the transparent elastic body 21 may be protected.

A marker with a geometric pattern is attached to the transparent elastic body 21 or the film 22 to visually recognize the appearance of deformation caused by the contact part 20 in contact with the object. A detailed description of the marker is given below. Further, in the transparent elastic body 21 and the film 22, a suction hole 23, which is a through hole, is formed at a position corresponding to the through hole 35 of the first layer 31 of the bottom plate 30.

The suction container 40 is a container-shaped member having one end connected to the suction hole of the housing and another end connected to the through hole of the third layer of the bottom plate. The suction container 40 is formed of, e.g., resin or metal. It may be the same member as the housing 10. By the suction container 40, a flow path through which air passes from the through hole 34 of the third layer 33 of the bottom plate 30 to the discharge hole 11 of the housing 10 is formed.

The camera part 50 is a camera. The camera part 50 captures the object through the bottom plate 30 and the contact part 20. Furthermore, the camera part 50 captures the marker attached to the transparent elastic body 21 or the film 22 of the contact part 20. The camera part 50 includes a light receiving element that outputs an electric signal according to light reception, and a plurality of optical systems that form a plurality of images on the light receiving element. A detailed description of the camera part 50 is given below.

The lighting part 60 irradiates light for photographing by the camera part 50 from the inside of the housing 10 toward the contact part 20. The light by the lighting part 60 illuminates the bottom plate 30 and the contact part 20, and at the same time, illuminates the object through the bottom plate 30 and the contact part 20. The lighting part 60 includes a light source 61 and a diffusion plate 62. The light source 61 is implemented using, e.g., a light emitting diode (LED). The diffusion plate 62 is formed of, e.g., a light-transmitting resin to diffuse transmitted light. By interposing the diffusion plate 62, light emitted from the light source 61 is diffused to uniformly illuminate the target and the marker attached to the contact part 20.

### <Suction Structure of Holding Device 1>

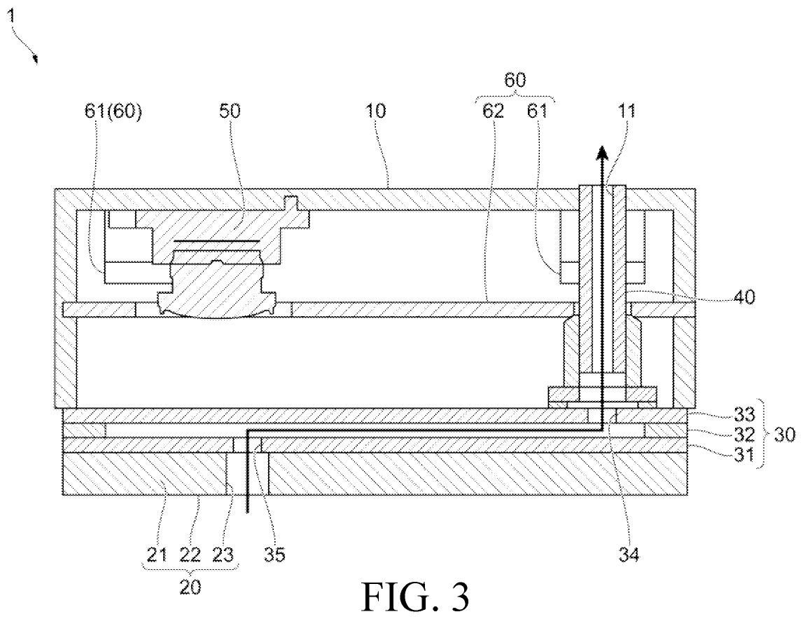

FIG. 3 is a view illustrating a suction structure of a holding device 1 according to an embodiment of the disclosure.

Referring to FIG. 3, a suction hole 23 is formed in the contact part 20. In the bottom plate 30, a through hole 35 is formed in the first layer 31, a through hole 34 is formed in the third layer 33, and a flow path connecting the through hole 35 of the first layer 31 and the through hole 34 of the third layer 33 is formed by the second layer 32. The suction container 40 is a container connecting the through hole 34 of the third layer 33 of the bottom plate 30 and the discharge hole 11 of the housing 10. The discharge hole 11 of the housing 10 is connected to a suction device (not shown). If the suction device is operated, air around the suction hole 23 of the contact part 20 is sucked from the suction hole 23, and is discharged through the flow path inside the bottom plate 30 and the suction container 40 to the discharge hole 11. By the suction structure configured as described above, the object positioned in the suction hole 23 of the contact part 20 is sucked to the contact part 20 and held by the holding device 1.

### <Configuration of Bottom Plate 30>

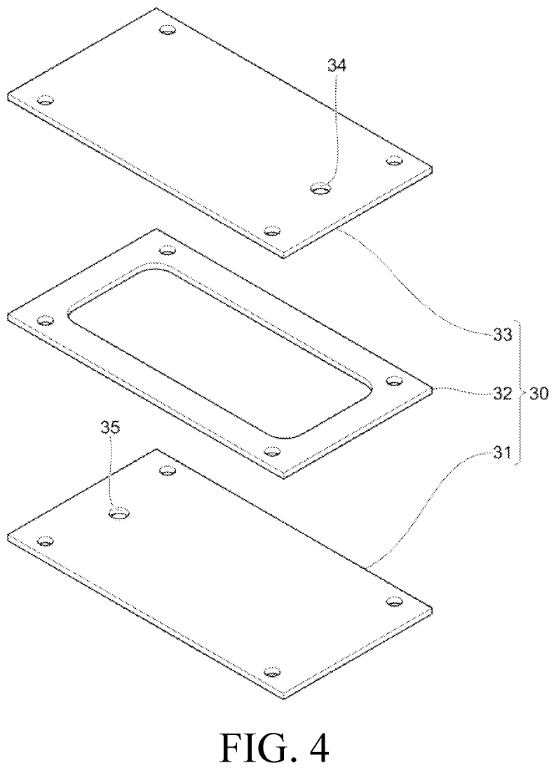

FIG. 4 is a view illustrating a structure of a bottom plate 30 according to an embodiment of the disclosure.

The bottom plate 30 is formed by overlaying the first layer 31, the second layer 32, and the third layer 33. The first layer 31 is a plate-shaped member, and has a through hole 35. The second layer 32 is a frame member having a large opening in the central portion. The third layer 33 is a plate-shaped member, and has a through hole 34. The second layer 32 is formed around the outside of the positions corresponding to the through hole 35 of the first layer 31 and the through hole 34 of the third layer 33. Therefore, by overlaying the first layer 31, the second layer 32, and the third layer 33, a space from the through hole 35 to the through hole 34 is formed between the first layer 31 and the third layer 33. This space becomes a flow path through which air is sucked when the holding device 1 holds the object. Further, although the second layer 32 is a frame member here, the shape of the second layer 32 may be a shape that forms a flow path of air from the through hole 35 of the first layer 31 to the through hole 34 of the third layer 33 when overlaying the first layer 31, the second layer 32, and the third layer 33, and the specific shape is not particularly limited. For example, the second layer 32 may be a plate-shaped member having a long hole from the through hole 35 of the first layer 31 to the through hole 34 of the third layer 33.

### <Optical System of Holding Device 1>

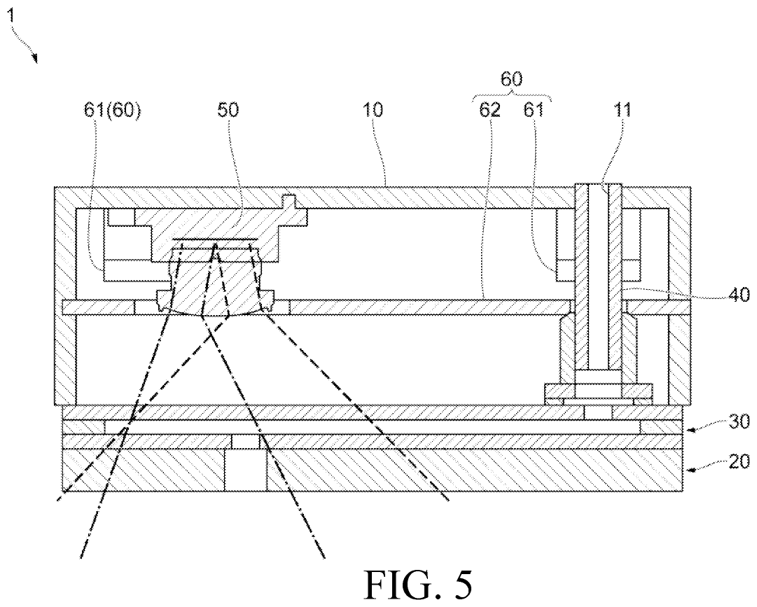

FIG. 5 is a view illustrating a configuration of an optical system of a camera part 50 of a holding device 1 according to an embodiment of the disclosure. The optical system of the holding device 1 is implemented in the camera part 50. The camera part 50 has two focal lengths of a long distance and a short distance, and may simultaneously capture a subject at a long distance and a subject at a close distance. The camera part 50 configured to capture an image of a surface of the contact part 20 and the object

Referring to FIG. 5, an example of a long photographing range is represented by a dash-single dotted line, and an example of a short photographing range is represented by a broken line. The subject at the long distance is a subject positioned at a place that has passed through the bottom plate 30 and the contact part 20, and specifically, it is an object by the holding device 1. The subject at the short distance is an outer side (side in contact with the object) of the contact part 20. A configuration for implementing a short focal length in the camera part 50 is an example of the first optical system, and a configuration for implementing a long focal length is an example of the second optical system.

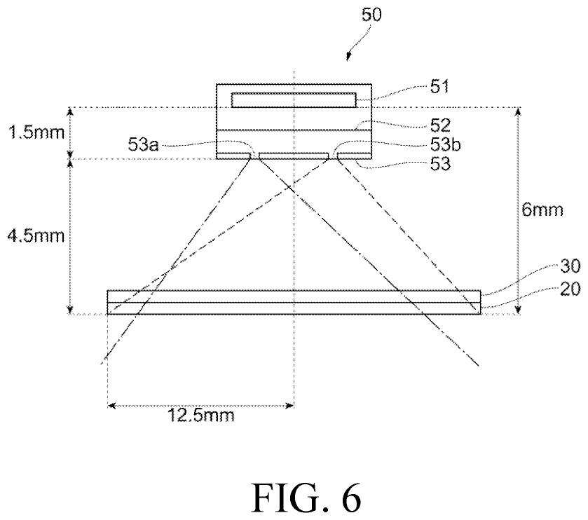

FIG. 6 is a view illustrating an example of a configuration of a camera part 50 according to an embodiment of the disclosure.

The camera part 50 includes an image sensor 51, a lens 52, and an aperture plate 53. The image sensor 51 converts light from the subject into an electrical signal. The image sensor 51 is a light receiving element group, and uses, e.g., a contact image sensor (CIS). The lens 52 collects light from the subject on the image sensor 51, forming an image. As the lens 52, e.g., a meta lens is used. The camera part 50 includes one lens 52, and in the lens 52, long-distance and short-distance focuses are set. The aperture plate 53 has two openings 53a and 53b and adjusts light incident on the lens 52.

The lens 52 has a long-distance focus and a short-distance focus set at different positions. As an example, it is assumed that a long-distance focus is set on the left side of the lens 52 in FIG. 6 and a short-distance focus is set on the right side. The opening 53a of the aperture plate 53 corresponds to a position where the long-distance focus of the lens 52 is set. The opening 53b of the aperture plate 53 corresponds to a position where a short-distance focus of the lens 52 is set. Therefore, in the example shown in FIG. 6, light from the long-distance subject is incident on the right side of the lens 52 (see the arrow in the dash-single dotted line in the drawing), and light from the short-distance subject is incident on the left side of the lens 52 (see the arrow of the broken line in the drawing). Further, an image of the long-distance subject and an image of the short-distance subject may be formed in different areas on the image sensor 51. The image sensor 51 transmits the electrical signal based on the formed image to a processing device (not shown). The processing device generates image data of the long-distance subject and image data of the short-distance subject based on the electrical signal received from the image sensor 51. As a result, the objects are detected.

In the configuration example shown in FIG. 6, the distance from the image sensor 51 to the aperture plate 53 (the subject-side surface of the lens 52) is 1.5 mm. Further, the distance from the aperture plate 53 to the surface (lower surface in the drawing) in contact with the object of the contact part 20 is 4.5 mm. Further, the distance from the image sensor 51 to the surface in contact with the object of the contact part 20 is 6 mm. Further, the field of view at the surface of the contact part 20 in contact with the object is 25 mm (12.5 mm×2). For example, for the focal length of the lens 52, the short distance is set to 4.5 mm, which is the distance to the film 22 (the surface in contact with the object) of the contact part 20, and the long distance is set to about 10 to 20 mm.

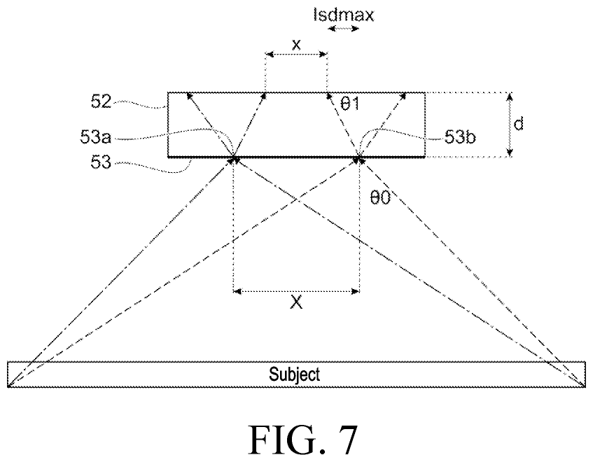

FIG. 7 is a view schematically illustrating a configuration in which a camera part 50 obtains two images of a short distance and a long distance according to an embodiment of the disclosure.

Referring to FIG. 7, the lens 52 and the aperture plate 53 are shown among the components of the camera part 50, and the image sensor 51 is omitted. Here, it is described that an image is formed on a surface (lower surface in the drawing), opposite to the subject, of the lens 52. Hereinafter, the image-forming surface, opposite to the subject, of the lens 52 is formed is referred to as an imaging surface. Further, the camera part 50 simultaneously capture both the subject positioned at a short distance and the subject positioned at a long distance, but only one subject is described in FIG. 7 for simplicity.

Referring to FIG. 7, the state in which the light emitted from the subject at the short distance reaches the imaging surface of the lens 52 is indicated by a broken-line arrow. Light emitted from the subject positioned at the short distance is imaged on a portion (a right area in the drawing) of the imaging surface of the lens 52 through one opening 53b of the aperture plate 53. Hereinafter, the image of the subject at the closer position, formed on the imaging surface of the lens 52 is referred to as a “short-distance subject image”.

Further, the state in which light emitted from the subject at the long distance reaches the imaging surface of the lens 52 is represented by a dash-single dotted line arrow. Light emitted from the subject at the long distance is imaged on a portion (left area in the drawing) of the imaging surface of the lens 52 through the other opening 53a of the aperture plate 53. Hereinafter, the image of the subject at the long distance formed on the imaging surface of the lens 52 is referred to as a “long-distance subject image”. It is assumed that the short-distance subject image and the long-distance subject image are formed in a circular or elliptical shape, respectively, on the imaging surface. Further, since the shapes or sizes of the short-distance subject image and the long-distance subject image are actually different, but the difference is slight, they are described as having the same shape and the same size here.

Here, it is preferable that the short-distance subject image and the long-distance subject image do not overlap on the imaging surface of the lens 52. In order to form the short-distance subject image and the long-distance subject image so as not to overlap, it is necessary to set the distance X between the opening 53a and the opening 53b in the aperture plate 53 as follows.

First, if the incident angle of light to the lens 52 is θ0, the refraction angle is θ1, and the refractive index of the lens 52 is N, Sin θ0=N×Sin θ1.

Next, if the maximum value of Sin θ0 is MaxSin θ0=1, the maximum value MaxSin θ1 of Sin θ1 is MaxSin θ1=1/N.

Next, a point A at a position corresponding to the opening 53a of the aperture plate 53 and a point B at a position corresponding to the opening 53b on the imaging surface of the lens 52 are assumed. Further, on the straight line connecting point A and point B, an edge position on the side close to point B in the short-distance subject image is assumed as point C. Point C is the closest point to point B in the short-distance subject image. And if the distance between points A and C is Isdmax and the thickness of the lens 52 (i.e., the distance between the subject side of the lens 52 and the imaging surface) is d, Isdmax=d/N.

Therefore, when the distance X between the opening 53a and the opening 53b is larger than the following value, the short-distance subject image and the long-distance subject image do not interfere.

$$X = 2 \times Isd max = 2 d / N$$

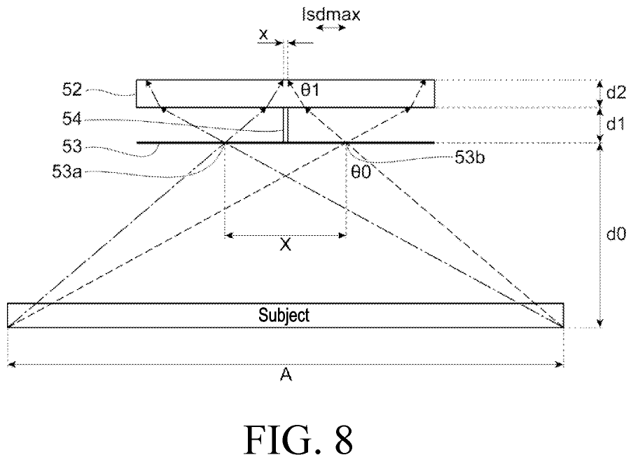

FIG. 8 is a view schematically illustrating another configuration in which a camera part 50 obtains two images of a short distance and a long distance according to an embodiment of the disclosure.

In the configuration shown in FIG. 7, the aperture plate 53 is in contact with the subject-side surface of the lens 52, but in the configuration shown in FIG. 8, there is a space between the aperture plate 53 and the subject-side surface of the lens 52. Between the aperture plate 53 and the lens 52, a partition plate 54 is disposed between the opening 53a and the opening 53b of the aperture plate 53 to divide the space including the aperture 53a and the space including the aperture 53b.

In the configuration shown in FIG. 8, among the components of the camera part 50, the lens 52 and the aperture plate 53 are shown, and the image sensor 51 is omitted. Further, it is assumed that an image is formed on the imaging surface (lower surface in the drawing) opposite to the subject of the lens 52. Further, the camera part 50 simultaneously captures both the subject positioned at the short distance and the subject positioned at the long distance, but only one subject is described in FIG. 8 for simplicity.

Referring to FIG. 8, the image of light emitted from a subject at a short distance reaching the imaging surface of the lens 52 is indicated by a broken arrow. Light emitted from the subject positioned at the short distance is incident on the lens 52 through one opening 53b of the aperture plate 53 and imaged on a portion (a right area in the drawing) of the imaging surface. Further, the state in which light emitted from the subject at the long distance reaches the imaging surface of the lens 52 is represented by a dash-single dotted line arrow. Light emitted from the subject at the long distance is imaged on a portion (left area in the drawing) of the imaging surface of the lens 52 through the other opening 53a of the aperture plate 53. It is assumed that the short-distance subject image and the long-distance subject image are formed in a circular or elliptical shape, respectively, on the imaging surface. Further, since the shapes or sizes of the short-distance subject image and the long-distance subject image are actually different, but the difference is slight, they are described as having the same shape and the same size here.

In order to form the short-distance subject image and the long-distance subject image so as not to overlap in the configuration shown in FIG. 8, it is necessary to set the distance X between the opening 53a and the opening 53b in the aperture plate 53 as follows.

First, it is assumed that the distance between the aperture plate 53 and the subject is d0, the distance between the aperture plate 53 and the lens 52 is d1, and the thickness of the lens 52 (i.e., the distance between the subject-side surface of the lens 52 and the imaging surface) is d2.

As in the case of the configuration shown in FIG. 7, if the incident angle of light to the lens 52 is θ0, the refraction angle is θ1, and the refractive index of lens 52 is N, Sin θ0=N×Sin θ1.

Further, if the maximum value of Sin θ0 is MaxSin θ0=1, the maximum value MaxSin θ1 of Sin θ1 is MaxSin θ1=1/N.

As in the case of the configuration shown in FIG. 7, a point A at a position corresponding to the opening 53a of the aperture plate 53 and a point B at a position corresponding to the opening 53b on the imaging surface of the lens 52 are assumed. Further, on the straight line connecting point A and point B, an edge position on the side close to point B in the short-distance subject image is assumed as point C. If the distance between points A and C is Isdmax, Isdmax=d2/N.

Further, if the size of the direction along the straight line connecting points A and B of the subject is Y, and the distance X between the opening 53a and opening 53b is larger than the following value, the short-distance subject image and the long-distance subject image do not interfere.

$$\begin{matrix}X = ( Y / 2 ) \times d 1 / d 0 + 2 \times Isd max \\ = ( Y / 2 ) \times d 1 / d 0 + 2 \times d 2 / N\end{matrix}$$

### <Operation of Holding Device 1>

Next, an operation of holding the object by the holding device 1 is described. Here, an operation of holding a connector part of a flexible flat cable (FFC) which is the object by the holding device 1 is described in an example of a process of holding the FFC-connected connector and mounting it in a socket installed on a substrate.

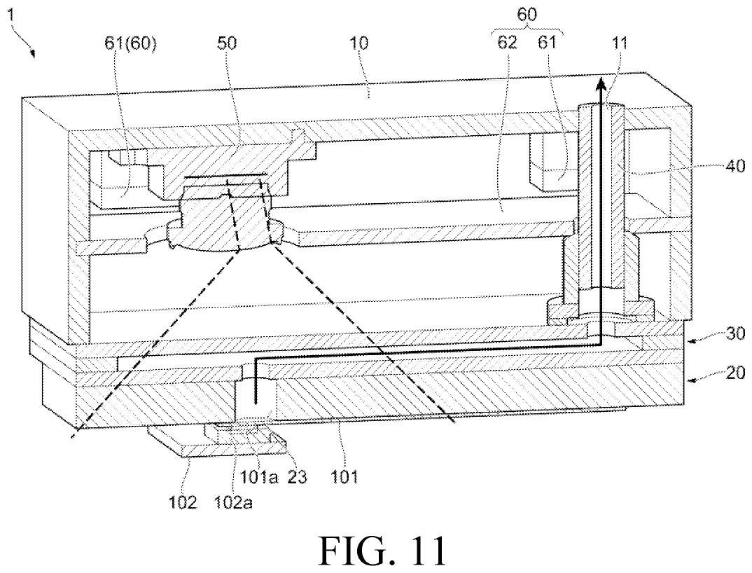

FIG. 9 is a view illustrating a state in which a holding device 1 detects a connector, as an object, and a socket where the connector is to be mounted according to an embodiment of the disclosure. FIG. 10 is a view illustrating a state in which a holding device 1 holds a connector according to an embodiment of the disclosure. FIG. 11 is a view illustrating a state in which a connector held by a holding device 1 is mounted in a socket according to an embodiment of the disclosure. FIG. 12 is a view illustrating a state in which a holding device 1 releases holding of a connector according to an embodiment of the disclosure.

In an initial state, the FFC 101 in which the connector 101a is installed and the substrate 102 on which the socket 102a is installed are arranged at predetermined initial positions. In this state, the holding device 1 first moves to an initial position where the camera part 50 may capture the connector 101a and the socket 102a according to the arrangement of the FFC 101 and the substrate 102. In particular, although not shown, the holding device 1 is mounted on the arm part (robot arm) and is movable according to the operation of the arm part. As shown in FIG. 9, at the initial position, the holding device 1 capture the connector 101a and the socket 102a, which are long-distance subjects, by the camera part 50 (see the photographing range by dash-single dotted line). Thus, a control device (not shown) detects the connector 101a and the socket 102a at a long distance.

Next, the holding device 1 is moved by the operation of the arm part, and the contact part 20 of the holding device 1 contacts the connector 101a. In this case, as shown in FIG. 10, the holding device 1 captures the connector 101a and the socket 102a, which are subjects at a short distance, by the camera part 50 (see the photographing range by the broken line). Further, a control device (not shown) controls the operation of the arm part, and moves the holding device 1 so that the position of the suction hole 23 of the contact part 20 overlaps the position of the connector 101a. In this state, if a suction device (not shown) is operated under the control of the control device, air is sucked from the suction hole 23 (see the arrow in FIG. 10), and the connector 101a is sucked and held to the contact part 20.

Next, the holding device 1 is moved by the operation of the arm part, and the connector 101a held by the holding device 1 is mounted in the socket 102a. In this case, as shown in FIG. 11, the holding device 1 captures the connector 101a and the socket 102a, which are subjects at a short distance, by the camera part 50 (see the photographing range by the broken line). Further, a control device (not shown) controls the operation of the arm part and moves the holding device 1 to push the connector 101a into the socket 102a while the position of the connector 101a sucked by the suction hole 23 of the contact part 20 overlaps the position of the socket 102a.

Next, the suction device stops operating, and suction of the connector 101a by the holding device 1 is released. Further, the holding device 1 is operated by the control of the arm part by the control device and is spaced apart from the connector 101a. In this case, as shown in FIG. 12, the holding device 1 capture the connector 101a and the socket 102a, which are long-distance subjects, by the camera part 50 (see the photographing range by dash-single dotted line). And the control device, which is not shown, identifies that the connector 101a is mounted in the socket 102a based on the captured image.

In this disclosure, the captured image refer to an image of the object held by the contact part 20, or an image of the surface of the contact part 20 or the object to be held, which is captured (or photographed) by the camera part 50.

### <Configuration of Processing Device>

The processing device in this disclosure has the same name as the identification device.

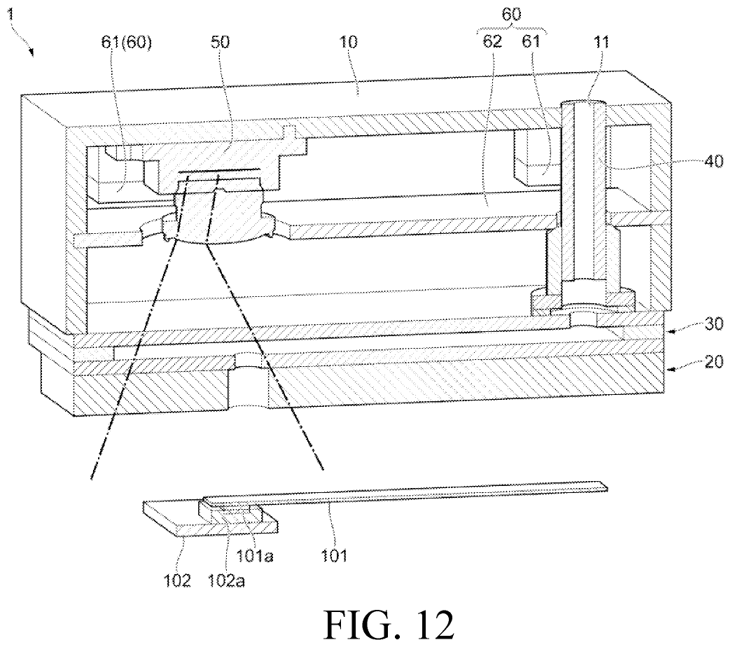

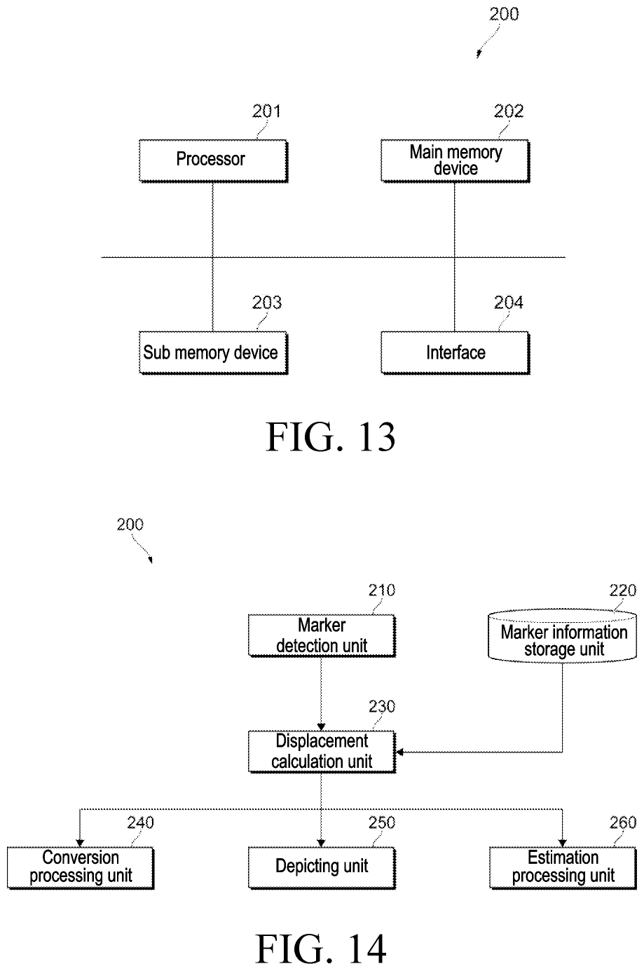

FIG. 13 is a view illustrating an example of a hardware configuration of a processing device according to an embodiment of the disclosure.

The processing device 200 includes one or more processors 201 as calculation means, main memory device (main memory) 202 as storage means, and sub memory device 203. The processor 201 executes various processes by reading and executing a program stored in the sub memory device 203 on the main memory device 202. For example, a central processing unit (CPU), a micro processing unit (MPU), a graphics processing unit (GPU), and a digital signal processor (DSP) are used as the processor 201. For example, random access memory (RAM) is used as the main memory device 202. For example, a magnetic disk device, a solid state drive (SSD) or the like is used as the sub memory device 203. Further, the processing device 200 includes an interface 204 that exchanges data with external devices such as the camera part 50 of the holding device 1, the arm part (robot arm), the suction device, and the display device. The configuration shown in FIG. 13 is merely an example, and the hardware configuration of the processing device 200 is not limited to the configuration example of FIG. 13.

FIG. 14 is a view illustrating a functional configuration of a processing device 200 according to an embodiment of the disclosure.

The processing device 200 includes a marker detection unit 210, a marker information storage unit 220, a displacement calculation unit 230, a conversion processing unit 240, a depicting unit 250, and an estimation processing unit 260. The processing device 200 may identify the state of the object held by the holding device 1, i.e., the contact state of the object and the contact part 20, based on the image captured by the camera part 50.

The estimation processing unit in this disclosure has the same name as the identification processing unit.

The marker detection unit 210 analyzes the image captured by the camera part 50 and detects the marker by the geometric pattern attached to the contact part 20. The function of the marker detection unit 210 is implemented as, e.g., the processor 201 shown in FIG. 13 executes a program.

The marker information storage unit 220 stores position information about the marker in the image of the marker captured by the camera part 50. The marker information storage unit 220 stores information about the initial position of the geometric pattern constituting the marker and information about the position where the marker was last detected from the image. The marker information storage unit 220 is implemented by, e.g., the main memory device 202 and the sub memory device 203 shown in FIG. 13.

The displacement calculation unit 230 calculates the displacement of the position of the geometric pattern constituting the marker. The displacement calculation unit 230 is implemented, e.g., as the processor 201 shown in FIG. 13 executes the program.

The displacement calculation unit 230 calculates the displacement for the position of the pattern captured immediately before, i.e., the last detected position stored in the marker information storage unit 220. Hereinafter, this displacement is referred to as a first displacement. The first displacement indicates how the marker moved in the immediately preceding state. The first displacement represents a change in the force applied to the contact part 20 by the object in contact with the contact part 20.

The displacement calculation unit 230 secondly calculates the displacement for the initial position of the pattern constituting the marker. Hereinafter, this displacement is referred to as a second displacement. The second displacement indicates how the marker moved at its initial position. The second displacement indicates how much force the contact part 20 has received by the object in contact with the contact part 20.

The conversion processing unit 240 calculates the force acting on the contact part 20 based on the first displacement and the second displacement calculated by the displacement calculation unit 230. The meaning of ‘based on the first displacement and the second displacement’ here can be the same as ‘based on the deformation amount. In other words, the conversion processing unit 240 converts the displacement of the marker calculated by the displacement calculation unit 230 into the force acting on the contact part 20. The force acting on the contact part 20 may include a pressure acting in a vertical direction with respect to the surface of the contact part 20, a shear force acting in a direction along the surface of the contact part 20, and a torque acting to rotate on the surface of the contact part 20. The conversion processing unit 240 is implemented, e.g., as the processor 201 shown in FIG. 13 executes the program. When the holding device 1 holds the object and performs an operation, various forces may be applied to the contact part 20 according to the posture of the object or the operation performed on the object. By obtaining the force acting on the contact part 20 by the conversion processing unit 240, the state (position, posture, etc.) of the object held by the holding device 1 or contact state of the object contacted to the contact part may be identified.

The depicting unit 250 draws the second displacement calculated by the displacement calculation unit 230 on the image of the marker to generate an image representing the displacement. The generated image is displayed, e.g., on a display device connected to the processing device 200, and is used for the user to visually identify the holding state of the object by the holding device 1. The depicting unit 250 is implemented, e.g., as the processor 201 shown in FIG. 13 executes the program.

The estimation processing unit 260 identifies the state of the object held by the holding device 1 based on the force acting on the contact part 20 calculated by the conversion processing unit 240. The identified state of the object (e.g., contact state) may include the posture of the object, the deformation of press-fitting in which the object pushes the surface of the contact part 20, and the like. The estimation processing unit 260 is implemented, e.g., as the processor 201 shown in FIG. 13 executes the program.

### <Detection of Displacement of Marker>

Next, a method of detecting a displacement of a marker attached to the contact part 20 is described. Detection of marker displacement includes, e.g., 1. marker detection processing, 2. marker corresponding-related processing in the initial image and the current image, and 3. displacement amount calculation processing. As a specific method for this processing, conventional methods may be used. Specifically, e.g., the Finger Vision method shown in the following document may be used.

project/Finger Vision/Software—Akihiko's Tech Note (akihikoy.net)·http://akihikoy.net/notes/?project%2FFingerVision%2FSoftware%2FM arkerTrack·GitHub-akihikoy/fingervision: Data processing programs for the vision-based tactile sensor FingerVision

In the present embodiment, since a black circle (dot) was used as the marker of the geometric figure, a black circle was detected in the detection process of the marker. The specific detection process may use, e.g., cv::SimpleBlobDetector of OpenCV (Open Source Image Processing Library). By this detection, the center image coordinates of each circle (dot) are obtained.

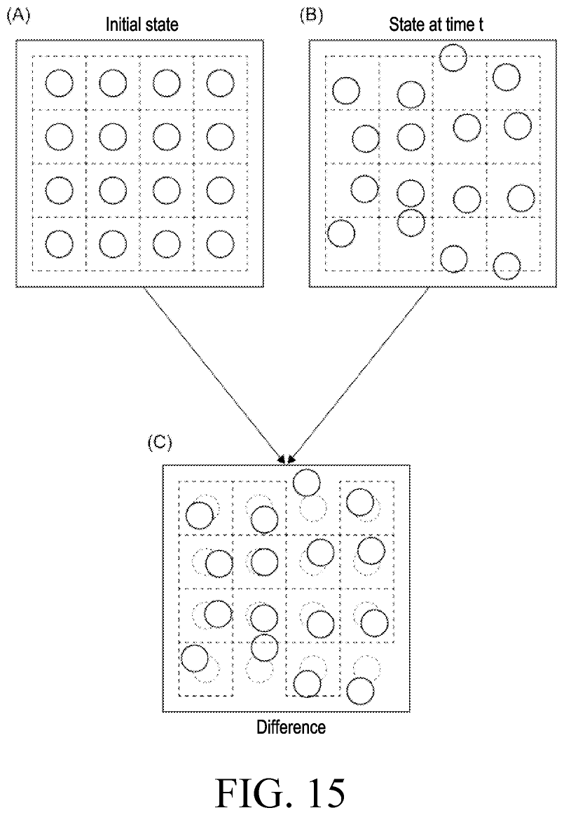

FIG. 15 is a view illustrating an example of displacement of a marker according to an embodiment of the disclosure. Part (A) of FIG. 15 is a view illustrating a marker in an initial state, part (B) of FIG. 15 is a view illustrating a marker state at time t, and part (C) of FIG. 15 is a view illustrating a state in which the marker positions of parts (A) and (B) of FIG. 15 overlap.

Referring to part (A) of FIG. 15, here, an example in which a pattern in which dots are arranged in a grid shape is used as a marker is shown. The grid line indicated by the broken line in part (A) of FIG. 15 represents the tracking range of each dot. Referring to part (B) of FIG. 15, at time t, as the holding device 1 holds the object and the surface of the contact part 20 is deformed, the dot pattern attached to the surface of the contact part 20 is distorted. For example, by comparing the position of each dot shown in part (A) of FIG. 15 and the position of each dot shown in part (B) of FIG. 15 to obtain the difference in position for each corresponding dot as shown in part (C) of FIG. 15, it is possible to recognize how the surface of contact part 20 is deformed at time t as compared with the initial state.

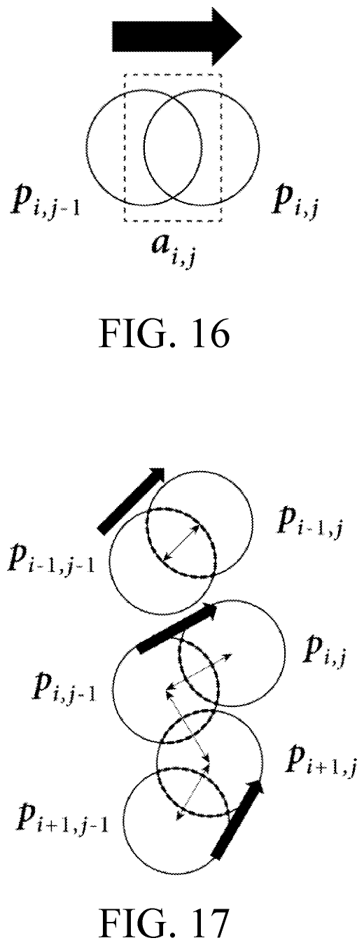

FIG. 16 is a view illustrating an example related to correspondence of dots when one dot is displaced according to an embodiment of the disclosure. Here, an example of obtaining a corresponding relationship between dots using the first displacement is shown. As a method of specifying the corresponding relationship of individual dots in two images, such as parts (A) and (B) of FIG. 15, e.g., a method of considering the overlap of dots in two images may be considered.

Referring to FIG. 16, the coordinates of the ith dot in the jth image frame among the image frames captured by the camera part 50 are p_{i,j}. Similarly, the coordinates of the ith dot in the j−1th image frame immediately before are set to p_{i,j-1}. The coordinate p of the dot is represented by a vector, but here, there is no special indication indicating that it is a vector, and it is simply described as p_{i,j}, p_{i,j-1}. Further, the area where the ith dots overlap in the jth image frame and the j−1th image frame is set to a_{i,j}. The displacement calculation unit 230 of the processing device 200 compares the jth image frame with the j−1th image frame, and determines that dots having overlapping areas in the two image frames are the same dots in the two image frames.

FIG. 17 is a view illustrating correspondence between a plurality of dots according to an embodiment of the disclosure.

Referring to FIG. 17, for the coordinate pᵢ₋₁ of the i−1th dot, the coordinate pi of the ith dot, and the coordinate pᵢ₊₁ of the i+1th dot, the detection result of the j−1th image frame and the detection result of the jth image frame are shown as overlapping. Here, attention is paid to the i+1th dot in the jth image frame. Then, this dot has an area overlapping the two areas of the ith dot and the i+1th dot in the j−1th image frame. In this case, e.g., the dot having the larger overlapping area may be determined to be the same dot. In the example of FIG. 17, the i−1th dot in the j−1th image frame and the i+1th dot in the jth image frame are determined to be the same dot.

Further, when the dots arranged in a grid shape move significantly due to the deformation of the contact part 20, the same dots may not be determined only by the size of the overlapping area by the above method. By assuming this situation in advance, a tracking range is set for each dot. The frame denoted in broken line shown in part (A) of FIG. 15 is the tracking range of each dot. Dots that have reached outside the tracking range due to displacement are excluded from the tracking target (detection target of displacement).

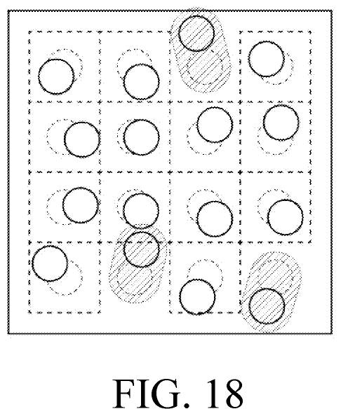

FIG. 18 is a view illustrating a dot excluded from a tracking target in the example of part (C) of FIG. 15 according to an embodiment of the disclosure.

Referring to FIG. 18, dots excluded from the tracking object are marked with diagonal lines. As a result of the displacement of each dot from the initial state shown in part (A) of FIG. 15 as shown in part (B) of FIG. 15, in the 4×4 dot columns, the third dot from the left of the first top row, the second dot from the left of the first bottom row, and the first right dot of the first bottom row are outside the tracking range. Accordingly, as shown in part (C) of FIGS. 15 and 18, these three dots are excluded from the tracking target.

The displacement calculation unit 230 of the processing device 200 has been described as calculating the first displacement and the second displacement for each dot. The first displacement is the difference between the position of each dot in the immediately prior image frame and the position of each dot in the current image frame. The second displacement is the difference between the position of each dot in the image frame in the initial state and the position of each dot in the current image frame.

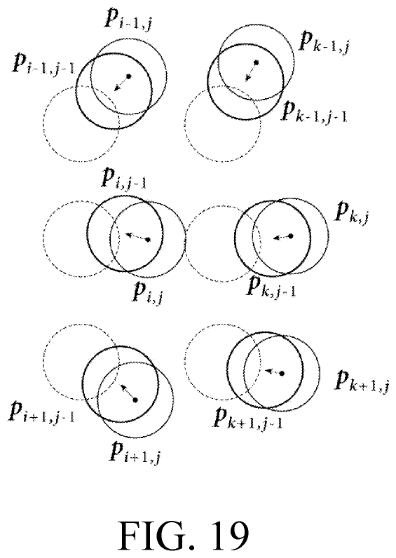

FIG. 19 is a view illustrating an example of first displacement according to an embodiment of the disclosure.

Referring to FIG. 19, the initial position, the detection result of the j−1th image frame, and the detection result of the j−1th image frame and the detection result of the jth image frame are shown as overlapping for the coordinate pᵢ₋₁ of the i−1th dot, the coordinate pᵢ of the ith dot, the coordinate pᵢ₊₁ of the i+1th dot, the coordinate pₖ₋₁ of the k−1th dot, the kth dot pₖ, and the k+1th dot pₖ₊₁. In FIG. 19, the initial position of each dot is indicated by broken line, the detection result of the j−1th image frame is indicated by thick solid line, and the detection result of the jth image frame is indicated by thin solid line. In FIG. 19, an arrow connecting the center of the dot, which is the detection result of the jth image frame, and the center of the dot, which is the detection result of the j−1th image frame, is shown in each dot. This arrow is an arrow indicating the corresponding relationship of each dot obtained by the first displacement of each dot.

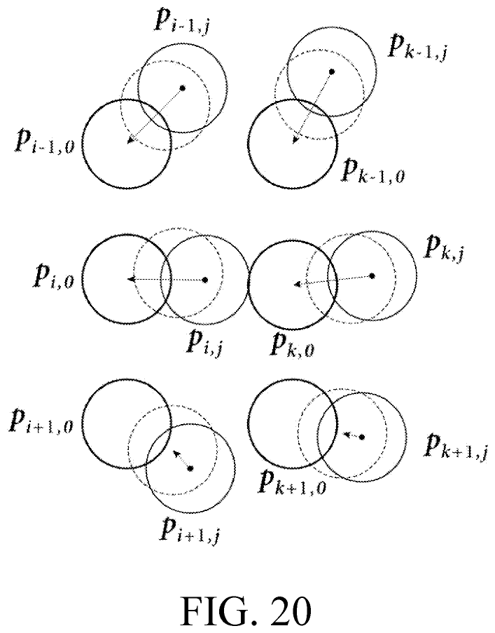

FIG. 20 is a view illustrating an example of second displacement according to an embodiment of the disclosure.

Referring to FIG. 20, the initial position, the detection result of the j−1th image frame, and the detection result of the j−1th image frame are shown as overlapping, for the coordinate pᵢ₋₁ of the i−1th dot, the coordinate pᵢ of the ith dot, the coordinate pᵢ₊₁ of the i+1th dot, the coordinate pₖ₋₁ of the k−1th dot, the coordinate pₖ of the kth dot, and the coordinate pₖ₊₁ of the k+1th dot. The initial position is a position in the 0th image frame, and is described such as the dot of the coordinates p_{i,0} and the dot of the coordinates p_{k,0} or the like. In FIG. 20, the initial position of each dot is indicated by thick solid line, the detection result of the j−1th image frame is indicated by broken line, and the detection result of the jth image frame is indicated by thin solid line. Further, in FIG. 20, an arrow connecting the center of the dot, which is the detection result of the jth image frame, and the center of the dot at the initial position is shown in the display of each dot. This arrow is an arrow indicating the corresponding relationship of each dot obtained by the second displacement of each dot.

The depicting unit 250 of the processing device 200 may generate an image indicating the second displacement as shown in FIG. 20 based on the second displacement calculated by the displacement calculation unit 230 and display the image on the display device. In this way, the user may visually recognize the second displacement of each dot while looking at the image displayed on the display device.

It has been described that the conversion processing unit 240 of the processing device 200 calculates the force acting on the contact part 20 based on the second displacement of the dots constituting the marker. The amount of displacement of the dots corresponds to the amount of deformation of the contact part 20.

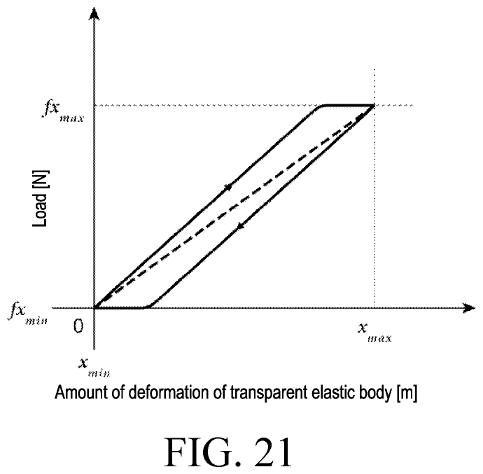

FIG. 21 is an expected diagram of the relationship between the force acting on the contact part 20 of the holding device 1 and the amount of deformation of the contact part 20, assuming that the transparent elastic body used in the contact part 20 is deformed with very ideal hysteresis according to an embodiment of the disclosure.

Referring to FIG. 21, the vertical axis is the force applied to the contact part 20. The horizontal axis is the displacement amount of the transparent elastic body. Further, in this drawing, the curve shown as an arrow toward the upper right end shows the trend when the load is loaded on the contact part 20, and the curve shown as an arrow toward the lower left end shows the trend when the load on the contact part 20 is limited. The straight line drawn by the broken line in the drawing is a straight line connecting the lowest and highest points of the curve within the area surrounded by two curves. If the slope of this straight line is k, this straight line is thought to be the trend of a spring with a diagonal spring constant k.

It is thought that the transparent elastic body used in the contact part 20 is deformed with very ideal hysteresis as shown in FIG. 21. In this case, the contact part 20 may be displaced in the x, y, and z-axis directions, respectively. FIG. 21 illustrates a case of deformation in the x-axis direction as an example. In this case, if the diagonal spring constant is kₓ, kₓ is obtained by the following equation (Equation 1).

$${k}_{x} = \frac{{f}_{{x}_{m ax}} - {f}_{{x}_{m i n}}}{{x}_{m ax} - {x}_{m i n}} \qquad Equation 1$$

This spring constant exists for each of the x, y and z-axis directions. Therefore, if all the diagonal spring constants are summarized as the spring integer matrix K, K may be expressed by the following equation (Equation 2).

$$\begin{matrix}K = [ \begin{matrix}{k}_{x} & 0 & 0 \\ 0 & {k}_{y} & 0 \\ 0 & 0 & {k}_{z}\end{matrix} ] \\ = [ \begin{matrix}\frac{{f}_{{x}_{m ax}} - {f}_{{x}_{m i n}}}{{x}_{m ax} - {x}_{m i n}} & 0 & 0 \\ 0 & \frac{{f}_{{y}_{m ax}} - {f}_{{y}_{m i n}}}{{y}_{m ax} - {y}_{m i n}} & 0 \\ 0 & 0 & \frac{{f}_{{z}_{m ax}} - {f}_{{z}_{m i n}}}{{z}_{m ax} - {z}_{m i n}}\end{matrix} ]\end{matrix} \qquad Equation 2$$

Since the spring constant K represents the ratio of the displacement and load of the transparent elastic body used in the contact part 20, it is also captured as a resolution of the optical tactile sensor in the holding device 1.

The force fᵢ generated in the arbitrary marker mi of the contact part 20 is expressed by the following equation (Equation 3) using the spring integer K with the 3D displacement amounts of the marker mi as dxᵢ, dyᵢ, and dzᵢ, respectively. Further, although the force fᵢ is expressed as a vector, it is simply denoted as fᵢ without any specific symbol indicating that it is a vector, except in the equation. The following force f_{avg} is also described in the same manner.

$$\begin{matrix}{f}_{i} = K [ \begin{matrix}{dx}_{i} \\ {dy}_{i} \\ {dz}_{i}\end{matrix} ] \\ = [ \begin{matrix}{k}_{x} & 0 & 0 \\ 0 & {k}_{y} & 0 \\ 0 & 0 & {k}_{z}\end{matrix} ] [ \begin{matrix}{dx}_{i} \\ {dy}_{i} \\ {dz}_{i}\end{matrix} ]\end{matrix} \qquad Equation 3$$

Further, the average force f_{avg} acting on the entire contact part 20 is expressed by the following equation (Equation 4) if the number of dots of the marker attached to the contact part 20 is N.

$${f}_{avg} = \frac{1}{N} {\sum }_{i = 1}^{N} {f}_{i} \qquad Equation 4$$

Further, the torque ti which is generated by an arbitrary marker m; around the center of the image captured by the camera part 50 is expressed by the following equation (Equation 5) if the distance from the center position of the image to the marker mi is rᵢ. Further, although the torque τᵢ and the distance rᵢ are expressed as vectors, they are simply denoted as τᵢ and rᵢ without any specific symbol indicating that they are vectors, except in the equation. The following force Tavg is also described in the same manner.

$${τ}_{i} = {r}_{i} \times {f}_{i} = [ \begin{matrix}{r}_{{y}_{i}} {f}_{{x}_{i}} - {r}_{{z}_{i}} {f}_{{y}_{i}} \\ {r}_{{z}_{i}} {f}_{{x}_{i}} - {r}_{{x}_{i}} {f}_{{z}_{i}} \\ {r}_{{x}_{i}} {f}_{{y}_{i}} - {r}_{{y}_{i}} {r}_{{x}_{i}}\end{matrix} ] \\ ( However , assuming {r}_{i} = [ \begin{matrix}{r}_{{x}_{i}} \\ {r}_{{y}_{i}} \\ {r}_{{z}_{i}}\end{matrix} ] ) \qquad Equation 5$$

In this case, the average torque Tavg acting on the contact part 20 is expressed by the following equation (Equation 6) using the number of dots as N and torque τᵢ.

$${τ}_{avg} = \frac{1}{N} {\sum }_{i = 1}^{N} {τ}_{i} \qquad Equation 6$$

### <Detection of the State of the Object>

When the holding device 1 performs work while holding the object, the contact part 20 is deformed according to the force applied to the contact part 20. The deformation of the contact part 20 is calculated based on the image of the marker of the contact part 20 captured by the camera part 50. From the calculated deformation of the contact part 20, the contact state of the object held by the holding device is identified.

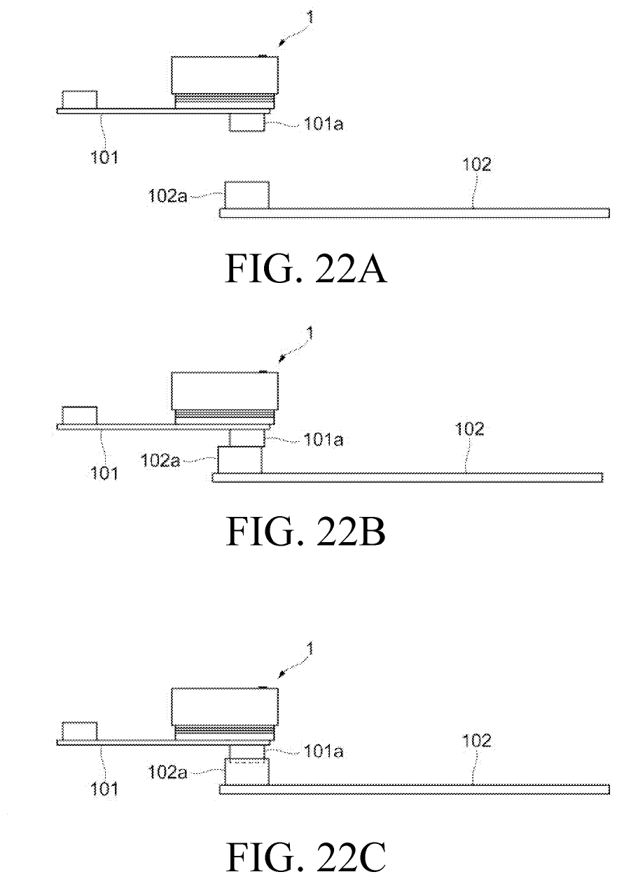

FIGS. 22A, 22B, and 22C are views illustrating an operation example of the holding device 1 according to an embodiment of the disclosure. FIG. 22A is a view illustrating a state in which the holding device 1 holds the object, FIG. 22B is a view illustrating a state in which the holding device 1 intends to install the object at the installation position, and FIG. 22C is a view illustrating a state in which the object is correctly installed at the installation position.

In FIG. 22A, the holding device 1 holds the object. The object is a connector 101a attached to the FFC 101. Although not shown, the holding device 1 is connected to the arm part (robot arm) and moves toward the installation position of the connector 101a by the operation of the arm part. The installation position of the connector 101a is the socket 102a installed on the substrate 102.

Here, it may be considered that the connector 101a is not mounted in the socket 102a because the position of the connector 101a is inaccurate. In the example shown in FIG. 22B, the connector 101a is in contact with the edge of the socket 102a and is not properly mounted. In this state, if the connector 101a is operated to be pushed into the socket 102a, the connector 101a receives a reaction force from the edge of the socket 102a and exerts torque on the contact part 20 sucking the connector 101a. The contact part 20 is deformed by the torque received from the connector 101a. The deformation of the contact part 20 is detected as a displacement of a dot of a marker attached to the contact part 20 in the image of the contact part 20 captured by the camera part 50.

The processing device 200 calculates a force acting on the contact part 20 based on the detected displacement of the dot of the marker, and identifies that the connector 101a is not properly mounted in the socket 102a and is receiving a force that causes a part of the connector 101a to return. The processing device 200 stops the operation of the arm part to the control device. Additionally, the processing device 200 operates the arm part to specify the position of the socket 102a based on the image captured by the camera part 50 and instructs the control device to operate the arm part to mount the connector 101a at the position of the newly specified socket 102a. In this way, the position of the connector 101a is adjusted, and as shown in FIG. 22C, the connector 101a is correctly mounted in the socket 102a.

An image captured by the camera part 50 in this disclosure is referred to as the captured image or a photographed image.

### <Modification>

Although the embodiment of the disclosure has been described above, the technical scope of the disclosure is not limited to the embodiment. For example, in the above embodiment, the marker attached to the contact part 20 is a pattern of dots arranged in grid. In contrast, based on the image captured by the camera part 50, various geometric patterns suitable for detecting deformation occurring in the contact part 20 may be used as markers.

Further, in the above embodiment, the bottom plate 30 has a three-layer structure, and the frame-shaped second layer 32 is sandwiched between the plate-shaped first layer 31 and third layer 33, forming a flow path of air in the suction mechanism. In contrast, as long as the bottom plate 30 supports the contact part 20 by the elastic body and implements a flow path of air in the suction mechanism, it is not limited to the three-layer structure. For example, it may be a two-layer structure formed of two plate-shaped members, and a flow path of air may be implemented by forming a groove or a concave portion in one or both members. In this case, in the two plate-shaped members, through holes corresponding to the through hole 35 of the first layer 31 and the through hole 34 of the third layer 33 shown in FIG. 4 are formed, and when the two plate-shaped members are overlaid, a groove or a concave portion is formed to connect the two through holes.

Further, the bottom plate 30 and the contact part 20 may be configured to be detachable and replaceable with respect to the holding device 1. In this way, the position of holding the object in the contact part 20 may be changed by preparing a plurality of bottom plates 30 and contact parts 20 with different positions of the suction hole 23 in advance and exchanging the bottom plate 30 and the contact part 20 according to the type of work.

Further, in the above embodiment, the camera part 50 is configured to include a plurality of optical systems in which a short-distance focal length and a long-distance focal length are set. In contrast, the camera part 50 may be a component including a plurality of optical systems having the same focal length set. With this configuration, a plurality of images with parallax may be obtained for one object to be captured (e.g., an object to be held), and the shape of the object to be captured may be stereoscopically grasped based on the difference in the way the object to be captured is seen due to parallax. Further, various modifications or alternative configurations that do not depart from the scope of the technical spirit of the disclosure are included in the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A holding device, comprising:
a housing including an opening;
a contact part covering the opening of the housing, formed of an elastic body having a transmittance, and configured to hold contact with an object;
a camera part disposed in the housing and configured to capture an image for a surface of the contact part and the object; and
an identification device configured to identify a contact state of the object and the contact part based on the image.

2. The holding device of claim 1,
wherein the contact part includes a suction hole for sucking air, and
wherein the holding device is configured to suck the object by sucking air from the suction hole by aligning a position of the suction hole to a position of the object.

3. The holding device of claim 1,
wherein a marker by a predetermined geometric pattern is attached to a surface, contacting the object, of the contact part, and
wherein the identification device is configured to identify the contact state of the object held on the contact part based on an deformation of the marker in the image captured by the camera part.

4. The holding device of claim 1, wherein a film formed of a resin having a transmittance is provided on a surface, configured to contact the object, of the contact part.

5. The holding device of claim 4,
wherein a marker by a predetermined pattern is attached to the film formed on the contact part, and
wherein the identification device is configured to estimate the contact state of the object held on the contact part based on an amount of displacement of the marker in the image captured by the camera part.

6. The holding device of claim 1, further comprising a lighting part configured to radiate light for photographing by the camera part to the contact part from an inside of the housing.

7. The holding device of claim 1, wherein the camera part includes:
a light receiving element group configured to output an electrical signal according to light reception; and
a plurality of optical systems configured to form a plurality of images on the light receiving element group.

8. The holding device of claim 7, wherein the plurality of optical systems of the camera part includes:
a lens; and
an aperture plate having a plurality of openings to allow a plurality of incident light beams to be incident on the lens to allow light passing through the lens to form the plurality of images on the light receiving element group.

9. The holding device of claim 8, wherein the plurality of optical systems of the camera part includes:
a first optical system configured to form an image on the light receiving element group by adjusting a focal length to a surface, configured to contact the object, of the contact part; and
a second optical system configured to form the image on the light receiving element group by adjusting the focal length to a position farther than the surface, contacting the object, of the contact part.

10. The holding device of claim 8, wherein the lens comprises one lens having a long distance focus set at a first part of the lens and a short distance focus set at a second part of the lens.

11. The holding device of claim 10,
wherein the light receiving element group comprises an image sensor, and
wherein an image from the first part of the lens is formed on a first part of the image sensor and an image from the second part of the lens is formed on a second part of the image sensor.

12. The holding device of claim 8, wherein the lens comprises a meta lens.
